(19) United States
(12) Patent Application Publication
(10) Pub. No.: US 2003/0051808 A1
(43) Pub. Date: Mar. 20, 2003

(54) Method of installing a tubular element

(75) Inventors: Peter Friedrich Herrmann, Triel Sur Seine (FR); Keku Mistry, Croissy Sur Seine (FR); Bernard Wurier, Valmondois (FR); Philipper Gauthier, Muret (FR)

Correspondence Address: SUGHRUE, MION, PLLC, 2100 Pennsylvania Avenue, N.W., Washington, DC, 20037-3213, US

(73) Assignee: ALCATEL

(21) Appl. No.: 10/243,679

(22) Filed: Sep. 16, 2002

(30) Foreign Application Priority Data
Sep. 17, 2001 (FR) 01 11 989

(51) Int. Cl. B32B 31/00

(52) U.S. Cl. 156/272.2; 156/293

(57) ABSTRACT

The present invention provides a method of installing a tubular element in a cavity. The method comprises the following steps: preparing a unit comprising said tubular element and a layer of a fixing compound which covers the entire outer periphery of said tubular element, at least over a fraction of its length; positioning said unit along the inside wall of said cavity; and applying activation treatment to said compound in such a manner as to fix said tubular element to said inside wall. The unit is preferably placed on the bottom of the cavity.

The present invention relates to a method of installing a tubular element in an existing cavity. The tubular element may be a cable or a pipe, and in particular it may be a hollow tube for receiving one or more cables. The cavity can be constituted in particular by a tubular cavity, for example a network of piping for collecting sewage or rain water. The invention relates more particularly to the operations that take place within non-pressurized underground tubular cavities of small diameter, in particular having a diameter of less than 200 millimeters (mm), such as a sewerage network or a drain pipe from a building, and in which direct visual and physical access is not possible.

### BACKGROUND OF THE INVENTION

In the ordinary way, the tubular element is fixed to the inside wall of an inaccessible cavity by fixing means that are spaced apart regularly. The fixing means are fixed in advance on the inside wall of the cavity, usually along the top thereof, by means of a remotely guided device. One problem lies in ensuring that such means are fixed strongly and durably to the wall of the cavity even though it can be made out of a variety of different materials. A drawback of that type of method is the requirement for the fixing means to be put into place in advance, which constitutes an operation that is lengthy and sometimes difficult. In addition, the fixing means constitute projections from the wall. Such projections run the risk of retaining solid residues moving along the duct, and of interfering with subsequent cleaning operations. A solution to the above problem has been provided by using a lining that covers the entire inside wall of the cavity.

Document GB-2 124 728 describes a cable television installation in an existing sewerage system. The cable is preferably suspended from the ceiling of the cavity. In order to hold the cable, that document proposes using an adhesive plastics material wound in a spiral along the cavity, the cable being sandwiched between the inside wall of the cavity and said lining material. Nevertheless, putting such a lining into place is lengthy and expensive since the entire surface of the cavity is covered in the adhesive material. Furthermore, the adhesion of said lining on the wall deteriorates over time. As a result the cable is no longer held properly, and portions of the lining can become detached, in particular they can become detached from the top portion of the cavity under the effect of gravity, thereby causing the cavity to be obstructed, at least in part.

Document JP-1 039 208 proposes holding a cable in place by means of a lining of flexible absorbent material. The lining, in the form of a bag, is inserted into the cavity by means of a fluid under pressure. A curing resin is sprayed onto the lining while it is being inserted. That method is particularly expensive, firstly because the entire surface of the cavity is covered in the lining material, and secondly because of the large amount of external infrastructure that is required in order to spray the resin.

Document DE-198 61 090 discloses a method of sticking an optical fiber cable into place by means of an adhesive layer previously deposited on the object to be fixed. A thrust device holds the article along the line of lay, and applies the adhesive to the wall. The adhesive layer can temporarily be covered in a protective film in order to make operations easier. Under such circumstances, the film is removed by means of a film-removal device prior to the body of the cable being pressed against the wall of the ducting. That method presents the drawback of not being applicable to a tubular element. In order to be able to deposit a sufficient quantity of adhesive on the article to ensure good fixing, the article needs to be concave in shape to provide a hollow for containing the adhesive. Adhesion is obtained by flattening the concave side against the wall. The quality with which the article is fixed to the wall by that method is not satisfactory since adhesion of the article on the wall involves only a relatively small portion of the periphery of the article, corresponding to the area of the hollow. In addition, adhesion will inevitably deteriorate over time and the article will end up becoming detached from the wall.

### OBJECTS AND SUMMARY OF THE INVENTION

An object of the present invention is to eliminate the drawbacks of the prior art, and to this end it provides a method of installing a tubular element in an existing cavity, which method is quick and of low cost, while nevertheless ensuring fixing that is longer-lasting.

The present invention provides a method of installing a tubular element in a cavity, the method being characterized in that it comprises the following steps:

preparing a unit comprising said tubular element and a layer of a fixing compound which covers the entire outer periphery of said tubular element, at least over a fraction of its length;

positioning said unit along the inside wall of said cavity; and

applying activation treatment to said compound in such a manner as to fix said tubular element to said inside wall.

In the method of the present invention, both the tubular element and its fixing means are inserted simultaneously into the cavity. The advantage of this method is that it avoids the need to put the fixing means for the tubular element previously into place on the inside wall of the cavity. In addition, the method is less expensive than a method that requires the entire cavity to be lined.

The unit formed by the tubular element associated with its fixing means is inserted in the cavity. The unit is preferably placed on the bottom of the cavity. In this way, there is no need to use means for holding the unit in a selected position until fixing has been ensured between the tubular element and the inside wall. This makes the method faster and easier to perform. The tubular element may be made of a plastics material, such as polyethylene, or out of a metal such as steel, which presents the advantage of withstanding rodents. When hollow, the tubular element can be filled with a liquid during the activation treatment in order to counteract the buoyancy thrust from the fixing compound while it is in the liquid state. When the tubular element is to be embedded completely in the fixing compound, it is preferable to use a corrugated metal tubular element which presents a saving in weight. Otherwise, the tubular element may be covered in metal in part only so as to be capable of withstanding rodents.

In a variant implementation of the invention, the fixing compound may be constituted by a tubular sheath placed coaxially around said tubular element containing an adhesive material in a liquid viscous state at ambient temperature, the assembly thus constituting a thick layer all around the tubular element. Said fixing compound preferably comprises an adhesive material selected from glue, resin, polyethylene, cement, concrete, and mixtures thereof. The fixing compound may also contain a repulsive additive for repelling rodents.

The activation treatment is at least one treatment selected from heat treatment, chemical treatment, and mechanical treatment. The activation treatment performs two functions that cause the tubular element to be fixed securely. Firstly, it deforms the layer of the fixing compound so as to increase its area of contact with the inside wall. Secondly it makes the compound adhere simultaneously to the inside wall and to the tubular element.

By way of example, heat treatment may be constituted by delivering a jet of steam at high temperature inside a hollow tubular element in order to cause the fixing compound to melt. It is also possible to pass an electrical current for the purpose of melting the fixing compound by the heat given off by the Joule effect when the tubular element is a hollow tube that is conductive, either because it is made of metal or else because it is lined along its length with one or more metal strips.

Chemical treatment may be implemented by delivering a chemical compound into the cavity, said compound being suitable-for reacting with the fixing compound in order to give it the above-mentioned necessary properties. In particular, the activation chemical treatment may consist in delivering a compound into the cavity which is suitable for triggering a chemical reaction between various ingredients making up the fixing compound. For example, in the simplest case, water can be used to make cement runny, which cement becomes insensitive to water once it has set.

When the fixing compound is constituted by a tubular sheath containing adhesive material, mechanical treatment may consist in tearing the sheath so as to reveal the adhesive material, and then optionally expelling the adhesive material from the sheath.

In a particular implementation of the invention, said activation treatment causes said fixing compound to change from the solid state to the liquid state, and preferably into a viscous liquid state. The fixing compound is then in the form of a liquid of consistency presenting thickness that depends on the operating conditions that have been selected as a function of the intended result. Under such circumstances, the compound covers that portion of the inside wall that is placed beneath the tubular element, and also both sides of the tubular element, which is thus fixed in reliable and long-lasting manner.

If the quantity of fixing compound and the operating conditions make this possible, the compound may fill the bottom of the cavity, possibly even covering the tubular element completely. Any irregularities in the wall at the bottom of the cavity are thus hidden, and the bottom of the cavity then presents a surface that is horizontal, plane, and relatively smooth.

Naturally, a plurality of the above-mentioned activation treatments may be implemented simultaneously or in combination, for example by combining mechanical treatment with heat treatment.

The method of the invention presents numerous advantages. It is simple to implement and it is quicker than known methods. In particular it avoids the need for fixing means to be installed beforehand since the fixing means are inserted simultaneously with the tubular element. Roughnesses are reduced, thereby serving both to make the cavity easier to clean and also avoiding interfering with flow within the cavity, in particular the flow of sewage or of rain water. The method can be used in any type of cavity regardless of its shape, even if the wall presents projections. Indeed, the method presents the advantage of hiding defects in the portion of the cavity wall on which the tubular element is fixed. Finally, when the tubular element is placed on the bottom of the cavity, then aging does not give rise to the unwanted consequences of the prior art method that relies on a lining that also covers the ceiling of the cavity.

The tubular element is installed in definitive manner, and when the hollow tubular element is to receive cables, it can be used subsequently without any further action being taken. Optical fiber cables may be passed through the element initially, but the initial cables may subsequently be changed without difficulty. It is even possible to change the purpose for which the hollow tube is used, providing materials remain compatible, and it could be used, for example, as a duct for conveying a fluid.

### BRIEF DESCRIPTION OF THE DRAWINGS

Other characteristics and advantages of the present invention will appear on reading the following description of an embodiment, naturally given by way of non-limiting illustration, and with reference to the accompanying drawings, in which:

FIG. 1 shows a first embodiment of a unit prior to being installed in the cavity;

FIG. 2 shows the FIG. 1 unit after it has been installed in the cavity;

FIG. 3 is a section through the cavity in a first implementation of the invention showing the tubular element after it has been installed;

FIG. 4 is a section through the cavity in a second implementation of the invention showing the tubular element after it has been installed;

FIG. 5 shows a second embodiment of a unit prior to installation in the cavity;

FIG. 6 shows a third embodiment of a unit prior to installation in the cavity; and

FIG. 7 shows a fourth embodiment of a unit prior to installation in the cavity.

### MORE DETAILED DESCRIPTION

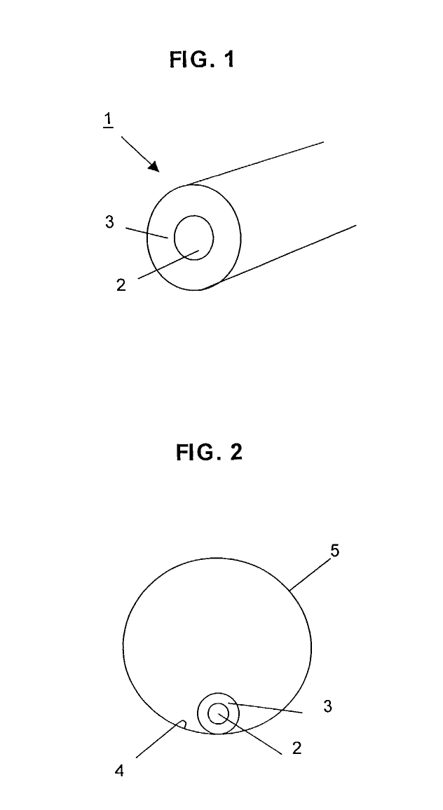

The unit 1 comprises a tubular element 2 coated in a thick layer of a fixing compound 3, as shown in FIG. 1. By way of example, the tubular element 2 is a hollow tube having a diameter of less than 10 mm, for receiving one or more cables, in particular optical fiber cables as used in telecommunications. Once the tube has been installed, cables placed within the tube can be changed or other cables can be added thereto without any need to repeat the operations involved in installing the tube. By way of example, the fixing compound 3 may be a hot-melt glue which is solid at operating temperatures.

The unit 1 is inserted into the cavity in such a manner as to rest on the bottom 4 of the cavity whose own diameter is about 100 mm, as shown in FIG. 2. As a general rule, installing the unit 1 in the cavity 5 involves at least two stages. A first stage comprises exploring and cleaning the walls of the cavity, while a subsequent stage involves the unit 1 being installed in the cavity 5, the unit 1 being entrained along the cavity 5 and being installed therein by means of a moving vehicle.

The walls of the cavity 5 can be cleaned by any conventional means, and it is preferable to use a remotely controlled moving device comprising means for propelling it in linear displacement and means for steering it in three dimensions. These means rely on jets of fluid under pressure and are controlled hydraulically or pneumatically. The moving device may be fitted with scanning and guidance means such as a camera, lighting means, means for identifying the vertical, and/or cleaning means. The cleaning means may comprise jets of fluid under pressure and a tool suitable for exerting physical action on the wall, such as a scraper, a wire brush, an abrading device, and any other instrument suitable for smoothing and clearing the inside surface of the wall of the cavity. Such cleaning needs to be performed thoroughly and completely, particularly concerning abrasion, in order to guarantee good adhesion of the tubular element on the wall.

In order to install the unit 1 in the cavity 5, it is possible to use a remote controlled moving device analogous to that used during the first stage. The unit 1 is pulled by the device and it is laid in the desired location on the bottom wall of the cavity 5. By using the device that performs the cleaning, it is possible also to install traction means, for example a cable or a cord serving to pull the unit to the desired location.

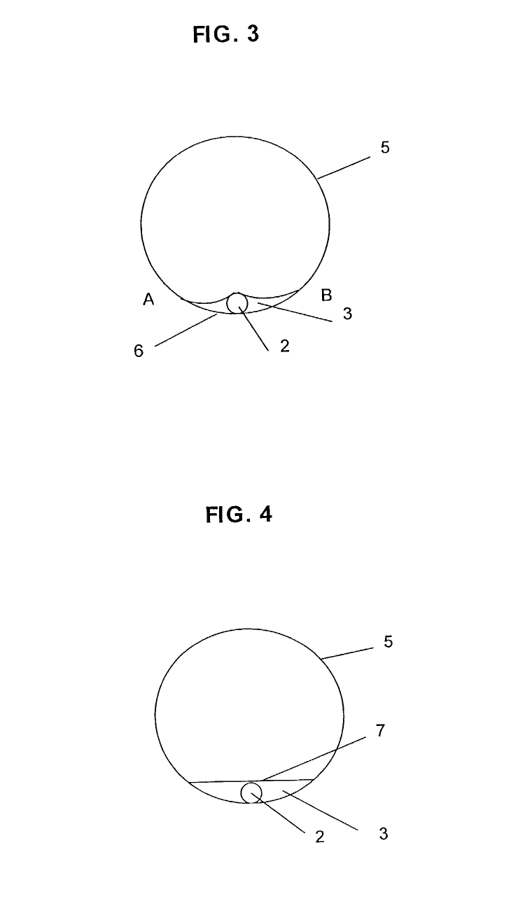

Once it is in place in the cavity 5, the unit 1 is subjected to activation heat treatment. A jet of steam is injected into the hollow tube 2 whose walls transmit the heat to the layer of hot-melt glue 3. The glue 3 then softens sufficiently to run and spread on either side of the tube 2, as shown in FIG. 3. Stopping steam admission allows the glue 3 to solidify on cooling, whereupon it adheres strongly both to the tube 2 and to the inside wall. Under such circumstances, the portion of the inside wall surface 6 with which the glue 3 comes into contact is represented by the circular arc extending between points A and B in FIG. 3. The tube 2 is installed in definitive manner and can be used subsequently without taking further action within the cavity. In the present case, the layer of fixing compound 3 is initially of a thickness which corresponds to a volume of glue that is 1 to 4 times the volume of the tubular element per unit length.

If the quantity of available hot-melt glue 3 is sufficient and if the temperature reached by the glue 3 gives it suitable fluidity, then melting the glue 3 leads to the bottom portion of the cavity 5 being filled as shown in FIG. 4. Under such circumstances, the layer of fixing compound 3 is initially of a thickness that corresponds to a volume of glue that is about 4 to 8 times the volume of the tubular element per unit length. After setting, the glue presents a horizontal surface 7 that is plane and without any troublesome roughnesses. The tubular element 2 is preferably embedded in the glue 3 so as to avoid forming any projection on the surface 7. Under such circumstances, it is preferable to use a tube that presents corrugations. Such a surface 7 presents the dual advantages of hiding any defects in the bottom portion of the wall of the cavity 5, and of providing a surface of improved quality that enhances the use of the cavity 5 for other functions.

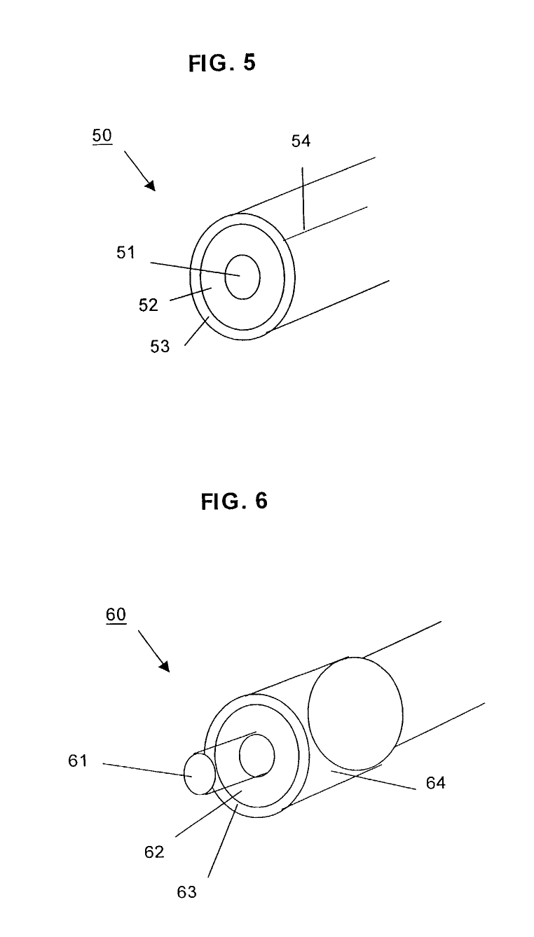

Other embodiments of the unit of the invention are shown in FIGS. 5 to 8.

FIG. 5 shows a unit 50 comprising a tubular element 51 covered in a fixing compound constituted by adhesive material 52 having the consistency of a thick liquid, such as a glue, and enclosed in a bag 53, e.g. made of polymer. The bag 53 has a line of weakness 54 parallel to the axis of the unit 50 and designed to be torn mechanically in order to release the adhesive material 52. The torn bag is preferably removed so as to avoid interfering with fixing the tubular element to the wall.

FIG. 6 shows circumstances in which the bag 63 does not include a line of weakness. The unit 60 is constituted by the tubular element 61 covered in a fixing compound analogous to that of FIG. 5, being constituted by an adhesive material 62 contained in a bag 63. The bag 63 is removed by being turned inside out and by pulling back the “cuff” 64 formed in this way.

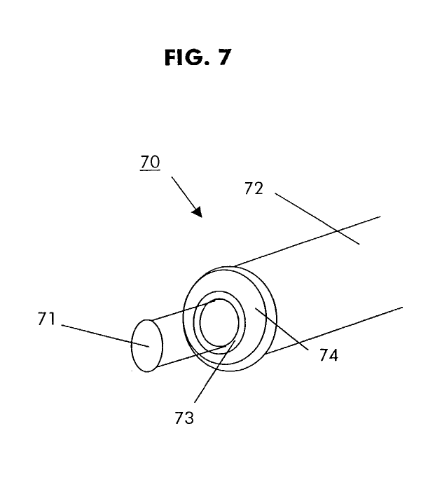

In another variant embodiment shown in FIG. 7, the unit 70 is constituted by a tubular element 71 covered in a fixing compound analogous to that of FIG. 6. The bag 72 containing the adhesive material 73 is terminated by a nozzle 74 of conical shape whose end surrounds the tubular element 71 in such a manner as to leave a gap filled with adhesive material 73. Once the unit 70 is in place, pressure is applied to the end of the bag 72 that is outside the cavity. The bag 72 is then torn and withdrawn by applying traction to pull back the nozzle 74. The layer of adhesive material left on the tubular element 71 has the consistency of a thick liquid and therefore spreads over the wall of the cavity on either side of the tubular element 71.

The method of the invention is described above for installing a single tubular element, however the method is naturally also applicable to installing a plurality of tubular elements, optionally of different diameters, having functions that may be similar or different. The tubular elements may be disposed side by side or they may be superposed.

1/ A method of installing a tubular element in a cavity, the method being characterized in that it comprises the following steps:
preparing a unit comprising said tubular element and a layer of a fixing compound which covers the entire outer periphery of said tubular element, at least over a fraction of its length;
positioning said unit along the inside wall of said cavity; and
applying activation treatment to said compound in such a manner as to fix said tubular element to said inside wall.

2/ A method according to claim 1, in which said unit is positioned on the bottom of said cavity.

3/ A method according to claim 1, in which said tubular element is made of metal or of a plastics material.

4/ A method according to claim 3, in which said tubular element is corrugated.

5/ A method according to claim 1, in which said fixing compound is constituted by a tubular sheath coaxial with said tubular element and containing an adhesive material.

6/ A method according to claim 1, in which said fixing compound comprises an adhesive material selected from: glue, resin, polyethylene, cement, concrete, and mixtures thereof.

7/ A method according to claim 1, in which said activation treatment causes said fixing compound to go from the solid state to the liquid state.

8/ A method according to claim 1, in which said activation treatment is at least one treatment selected from: heat treatment, chemical treatment, and mechanical treatment.

9/ A method according to claim 8, in which said heat treatment consists in delivering high temperature steam to the inside of said hollow tubular element.

10/ A method according to claim 8, in which said heat treatment consists in passing an electrical current.

11/ A method according to claim 8, in which said chemical treatment consists in delivering a chemical compound into said cavity, the compound being suitable for triggering a chemical reaction between certain ingredients of said fixing compound.

12/ A method according to claim 8, in which said mechanical treatment consists in perforating said tubular sheath.
